(19) United States
(12) Patent Application Publication
(10) Pub. No.: US 2009/0077095 A1
(43) Pub. Date: Mar. 19, 2009

(54) Metadata Management Apparatus

(75) Inventors: Shigeru Imai, Tokyo (JP); Shin Miura, Tokyo (JP); Takehiko Hanada, Tokyo (JP); Shinji Akatsu, Tokyo (JP); Yukimasa Sugino, Tokyo (JP); Masami Matsubara, Tokyo (JP); Susumu Oka, Tokyo (JP)

Correspondence Address: BIRCH STEWART KOLASCH & BIRCH, PO BOX 747, FALLS CHURCH, VA, 22040-0747, US

(73) Assignee: MITSUBISHI DENKIKABUSHIKI KAISHA, Tokyo (JP)

(21) Appl. No.: 11/919,706

(22) PCT Filed: May 17, 2005
(86) PCT No.: PCT/JP2005/008988

§ 371 Date: Oct. 31, 2007

(51) Int. Cl. G06F 17/30; G06F 7/00

(52) U.S. Cl. 707/10; 707/104.1; 707/100; 707/E17.032; 707/E17.044

(57) ABSTRACT

A metadata storing/receiving means 206 stores metadata acquired from a metadata providing terminal by using a metadata acquisition request. A filtering means 209 selects metadata stored in the metadata storage means 206 by using at least of a degree of preference and a degree of affinity.

### FIELD OF THE INVENTION

The present invention relates to a metadata management apparatus which acquires metadata from a metadata providing terminal connected to a network, and manages the metadata.

### BACKGROUND OF THE INVENTION

Conventionally, there has been provided a recommended information providing system in which two or more terminals connected to a network recommend information to each other (for example, refer to patent reference 1).

Such a recommended information providing system carries out the following operations. More specifically, an agent which is called a user agent moves to another user terminal specified by the user, and acquires recommended information. A provision-of-information permission means of the terminal which is the movement destination judges whether to provide the recommended information to the user agent. When the acquisition of the information is permitted by the provision-of-information permission means, a personal information management means acquires the recommended information from a personal information storage means, and then provides it to the user agent. The recommended information acquired by the user agent is then inputted to a presentation information generating means, and final recommended information is displayed on an output means.

[Patent reference 1] JP,2001-43233,A

A problem with the above-mentioned prior art system is, however, that whether the recommended information interests the user is dependent upon the terminal which is a recommended information acquisition destination specified by the user. More specifically, because the recommended information is generated directly from the personal information stored in the terminal specified by the user, the user has to examine whether a user who uses the recommended information source terminal can be trusted when specifying the terminal which is the recommended information source. Furthermore, because rearrangement and selection of the information are not carried out according to the liking of the user who receives the information, the user has to search for his favorite information through the recommended information.

The present invention is made in order to solve the above-mentioned problems, and it is therefore an object of the present invention to provide a metadata management apparatus which can acquire metadata of information which matches the liking of the user without the user's being conscious of whether the information matches the user's liking.

### DESCRIPTION OF THE INVENTION

A metadata management apparatus in accordance with the present invention is so constructed as to select metadata acquired from a metadata providing terminal by using at least of a user's degree of preference and degree of affinity.

Therefore, the metadata management apparatus can acquire metadata of information which matches the liking of the user without the user's being conscious of whether the information matches the user's liking.

### BRIEF DESCRIPTION OF THE DRAWINGS

FIG. 1 is a block diagram showing a metadata management apparatus in accordance with embodiment 1 of the present invention;

FIG. 2 is a block diagram of a system to which the metadata management apparatus in accordance with embodiment 1 of the present invention is applied;

FIG. 3 is a flow chart showing a flow of an operation sequence up to transmitting a metadata acquisition request in the metadata management apparatus in accordance with embodiment 1 of the present invention;

FIG. 4 is an explanatory view showing a terminal address list in the metadata management apparatus in accordance with embodiment 1 of the present invention;

FIG. 5 is an explanatory view of a selection screen displaying selection of information acquisition destinations in the metadata management apparatus in accordance with embodiment 1 of the present invention;

FIG. 6 is an explanatory view showing a data format of the metadata acquisition request in the metadata management apparatus in accordance with embodiment 1 of the present invention;

FIG. 7 is a flow chart showing an operation of receiving metadata from a metadata providing terminal of the metadata management apparatus in accordance with embodiment 1 of the present invention;

FIG. 8 is an explanatory view showing degrees of preference of the metadata management apparatus in accordance with embodiment 1 of the present invention;

FIG. 9 is an explanatory view showing degrees of affinity of the metadata management apparatus in accordance with embodiment 1 of the present invention;

FIG. 10 is a block diagram of a system to which the metadata management apparatus in accordance with embodiment 1 of the present invention is applied;

FIG. 11 is an explanatory view showing an example of a metadata display in the metadata management apparatus in accordance with embodiment 1 of the present invention;

FIG. 12 is an explanatory view showing an example of a display of a message at the time when the user selects contents which are the target for copyright protection management as information about metadata in the metadata management apparatus in accordance with embodiment 1 of the present invention;

FIG. 13 is an explanatory view of a group management table in a metadata management apparatus in accordance with embodiment 2 of the present invention;

FIG. 14 is an explanatory view showing an example of a display screen at the time when the user registers a group in the metadata management apparatus in accordance with embodiment 2 of the present invention;

FIG. 15 is an explanatory view showing an example of a screen at the time of registration of a group name in the metadata management apparatus in accordance with embodiment 2 of the present invention;

FIG. 16 is an explanatory view showing an example of a screen at the time of selection of a group in the metadata management apparatus in accordance with embodiment 2 of the present invention;

FIG. 17 is a block diagram of a metadata management apparatus in accordance with embodiment 3 of the present invention;

FIG. 18 is an explanatory view showing an example of a screen at the time of suggesting a group registration in the metadata management apparatus in accordance with embodiment 3 of the present invention;

FIG. 19 is a block diagram of a system to which a metadata management apparatus in accordance with embodiment 4 of the present invention is applied; and

FIG. 20 is an explanatory view showing a metadata acquisition request in the metadata management apparatus in accordance with embodiment 4 of the present invention;

### PREFERRED EMBODIMENTS OF THE INVENTION

Hereafter, in order to explain this invention in greater detail, the preferred embodiments of the present invention will be described with reference to the accompanying drawings.

### Embodiment 1

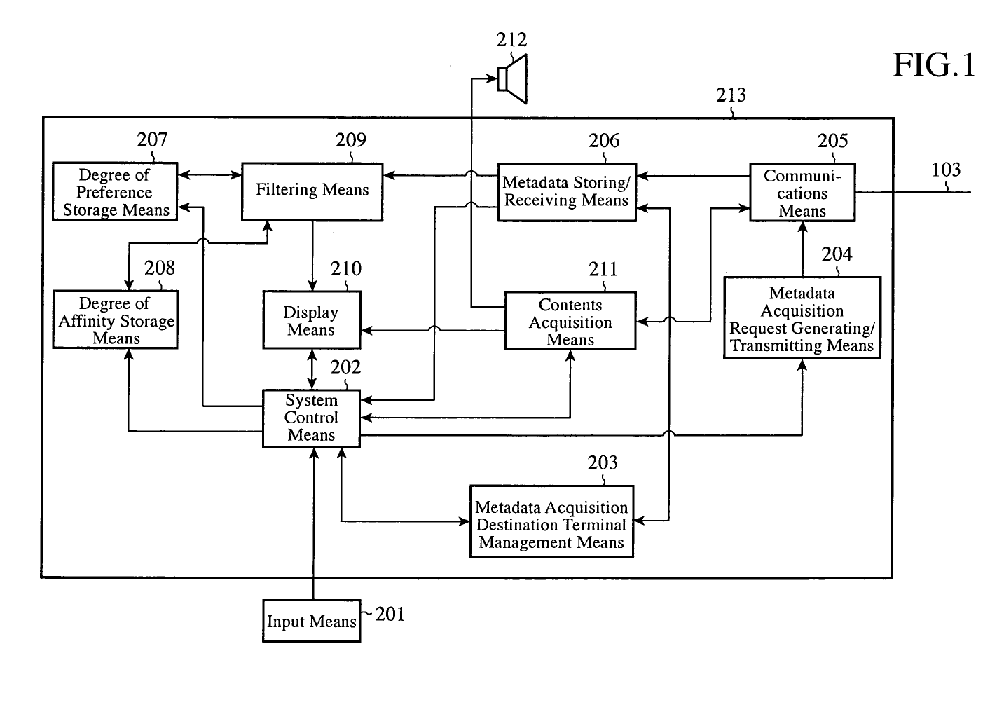

FIG. 1 is a block diagram showing a metadata management apparatus in accordance with embodiment 1 of the present invention.

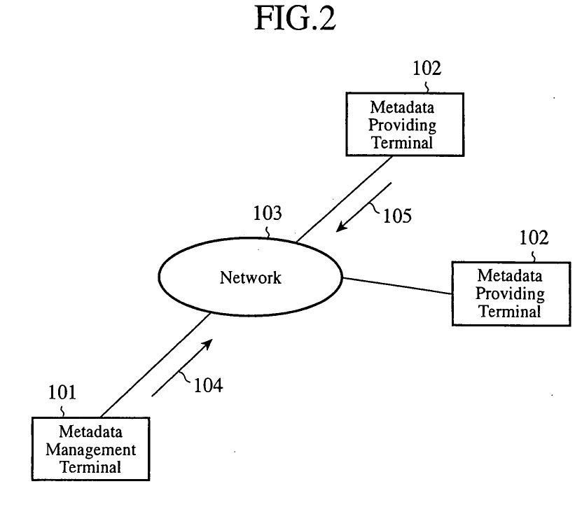

FIG. 2 is a block diagram of a system to which the metadata management apparatus in accordance with embodiment 1 of the present invention is applied.

First, a whole configuration of the system will be explained with reference to FIG. 2.

In FIG. 2, a metadata management terminal 101 and two or more metadata providing terminals 102 are connected to one another via a network 103. The metadata management terminal 101 is a terminal which is an application of the metadata management apparatus, and each metadata providing terminal 102 is a terminal which provides metadata to the metadata management terminal 101. The network 103 is a network which constructs a communication path between the metadata management terminal 101 and each metadata providing terminal 102, and is, for example, an IP network.

The metadata management terminal 101 is so constructed as to transmit a metadata acquisition request 104 to a metadata providing terminal 102 via the network 103, and to receive, as a response to the request, metadata 105 from the metadata providing terminal 102.

Next, the details of the metadata management terminal 101 will be explained with reference to FIG. 1. As shown in FIG. 1, the metadata management terminal 101 is provided with an input means 201, a system control means 202, a metadata acquisition destination terminal management means 203, a metadata acquisition request generating/transmitting means 204, a communications means 205, a metadata storing/receiving means 206, a degree of preference storage means 207, a degree of affinity storage means 208, a filtering means 209, a display means 210, a contents acquisition means 211, and a sound output means 212. Components including from the system control means 202 to the contents acquisition means 211 are disposed in a main body 213 of the terminal.

The input means 201 is a means for allowing the user to provide an input to the metadata management terminal 101, and is comprised of, for example, a keyboard, a pointing device, and so on. The system control means 202 is a control unit for controlling the whole of the metadata management terminal on the basis of the input from the input means 201. The metadata acquisition destination terminal management means 203 is a functional unit which manages an address for specifying a metadata providing terminal 102 on the network 103. The metadata acquisition request generating/transmitting means 204 is a functional unit which generates a metadata acquisition request 104 for making a request to acquire metadata, which is to be transmitted to a metadata providing terminal 102 connected to the network 103, and transmits the metadata acquisition request to the metadata providing terminal.

The communications means 205 is a communications interface which transmits the metadata acquisition request 104 generated by the metadata acquisition request generating/transmitting means 204 onto the network, and which receives metadata from a metadata providing terminal as a response to the request, and receives contents on the network which the metadata management terminal has identified by referring to the metadata. The metadata storing/receiving means 206 is a storage unit for storing the metadata received via the communications means 205 in the terminal. The degree of preference storage means 207 is a storage unit for storing the user's taste for the contents which is extracted from the metadata. The degree of affinity storage means 208 is a storage unit for storing the user's degree of affinity with each metadata providing terminal 102, which the metadata management terminal has determined by monitoring the user's using state of the metadata acquired from each metadata providing terminal 102.

The filtering means 209 is a functional unit which performs a selection operation or an alignment operation on the metadata stored in the metadata storing/receiving means 206 on the basis of both a degree of preference which it has acquired from the degree of preference storage means 207 and a degree of affinity acquired by the degree of affinity storage means 208. The display means 210 is a functional unit which provides a user interface for receiving the user's key input, via the system control means 202, from the input means 201, and for determining a display of a list of the metadata filtered by the filtering means 209, and destinations from each of which metadata are to be acquired, and which provides a web browser for displaying and operating a playback image of the contents acquired by the contents acquisition means 211, and Web contents.

The contents acquisition means 211 is a contents acquisition means which refers to the identifier of the contents associated with the metadata specified by the user so as to acquire the contents via the communications means 205, and which plays back the contents. The sound output means 212 is an output means which is comprised of a speaker for generating a sound output of contents, etc.

Next, the operation of the metadata management terminal 101 which is so constructed as mentioned above will be explained.

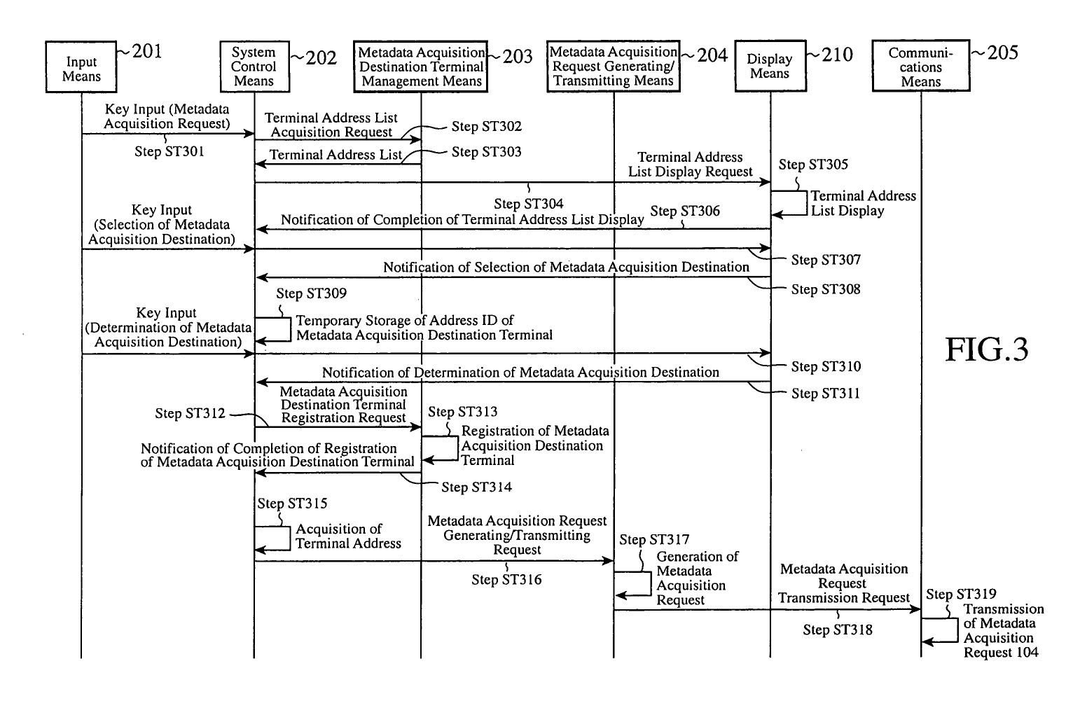

FIG. 3 is a flow chart showing a flow of an operation up to transmitting a metadata acquisition request 104 to a metadata providing terminal 102 on the network 103 in accordance with this embodiment.

The user makes a key input by using the input means 201 so as to notify a metadata acquisition request to the system control means 202 (in step ST301). Next, the system control means 202 transmits a terminal address list acquisition request to acquire a terminal address list to the metadata acquisition destination terminal management means 203 (in step ST302).

The metadata acquisition destination terminal management means 203 which has acquired the terminal address list acquisition request transmits, as a response, a terminal address list indicating information which makes it possible for each metadata providing terminal on the network 103 to be identified, the terminal address list registered beforehand therein, to the system control means 202 (in step ST303).

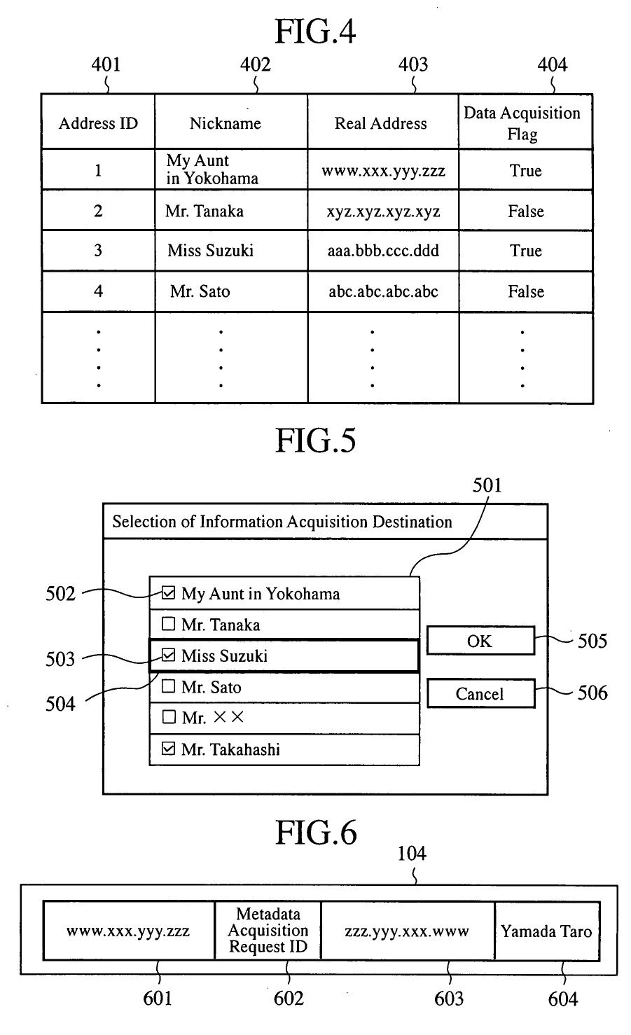

FIG. 4 is an explanatory view showing the terminal address list.

As shown in the figure, the terminal address list is a list which consists of combinations each including an address ID 401, a nickname 402, a real address 403, and a data acquisition flag 404, and a real address 403 can be acquired by specifying a corresponding address ID 401. An IP address, a telephone number, or the like can be provided, as a real address 403, according to the network used. A data acquisition flag 404 is a flag for determining whether to make a request of a corresponding terminal to acquire metadata information.

Next, the system control means 202 transmits the acquired terminal address list to the display means 210 and makes a terminal address list display request to display the terminal address list (in step ST304), and the display means 210 displays the terminal address list received together with the terminal address list display request, and urges the user to select, as a destination from which the metadata management terminal will acquire the metadata, a terminal (in step ST305).

FIG. 5 is an explanatory view of a selection screen for selection of an information acquisition destination.

In FIG. 5, a nickname 501 is information which is displayed by referring to a corresponding nickname 402 included in the terminal address list, and a check box 502 is a check box for enabling the user to select a terminal which corresponds to a nickname 501. A check mark 503 is a mark which is displayed when a corresponding check box 502 is checked. A cursor 504 is a cursor for enabling the user to select a check box 502 which the user desires to check. A OK button 505 is an instruction button for finally determining the selection of a terminal, and a cancel button 506 is an instruction button for canceling the selection of a terminal and then stopping the selection of the terminal.

When the display of the terminal address list is completed, the display means 210 transmits a notification of the completion of the terminal address list display to the system control means 202 so as to notify that the drawing of the user interface as shown in FIG. 5 is completed (in step ST306). The user makes a key input by using the input means 201, operates the screen as shown in FIG. 5, and selects a terminal of which the metadata management terminal makes a request to acquire metadata by checking a mark (in step ST307). The display means 210 which has received the user's input from the input means 201 by way of the system control means 202 causes the user interface included in the display means 210 to make a state transition, and transmits a notification of the selection of the metadata acquisition destination to the system control means 202 (in step ST308).

The system control means 202 which has received the notification stores temporarily an address ID which corresponds to each terminal to which the user has attached a check mark (in step ST309). When the user has selected, as the metadata acquisition destination, one or more terminals which he or she has convinced himself or herself to determine finally, the user makes a key input for pushing down the OK button 505 by using the input means 201 in order to finally determine the one or more terminals as the target of which the metadata management terminal will make a request to acquire metadata, and the key input is transmitted to the display means 210 via the system control means 202 (in step ST310). The display means 210 which has received the input causes the user interface included in the display means 210 to make a state transition, and transmits a notification of the determination of the metadata acquisition destination to the system control means 202 (in step ST311). Until the user presses down the OK button in step ST310, steps ST307, and ST308 and ST309 are repeated according to the user's input any number of times.

Because one or more terminals of which the metadata management terminal will make a request to acquire metadata are finally determined in step ST310, the system control means 202 makes a metadata acquisition destination terminal registration request of the metadata acquisition destination terminal management means 203 to register the one or more metadata acquisition destination terminals (in step ST312). The metadata acquisition destination terminal management means 203 which has received the metadata acquisition destination terminal registration request registers a data acquisition flag 404 in the terminal address list shown in FIG. 4 according to whether the user desires to acquire metadata from each terminal. In the case in which the user makes a request to acquire metadata from a terminal, the metadata acquisition destination terminal management means registers “True” into a corresponding data acquisition flag in the terminal address list, whereas in the case in which the user does not make a request to acquire metadata from a terminal, the metadata acquisition destination terminal management means updates a corresponding data acquisition flag to register “False” into this flag in the terminal address list (in step ST313). After completing the registration, the metadata acquisition destination terminal management means 203 notifies the system control means 202 that the registration of the one or more metadata acquisition destination terminals has been completed (in step ST314).

The system control means 202 verifies each address ID 401 acquired with the metadata acquisition destination selection input in step ST307 against the terminal address table as shown in the FIG. 4 which is acquired by the metadata acquisition destination terminal management means 203 so as to acquire a real address 403 which corresponds to the terminal specified by each address ID to actually transmit the metadata acquisition request to the terminal (in step ST315). Next, the system control means 202 transmits a metadata acquisition request generating/transmitting request to generate the metadata acquisition request 104 and transmit the metadata acquisition request 104 to the one or more acquired real addresses to the metadata acquisition request generating/transmitting means 204 (in step ST316).

The metadata acquisition request generating/transmitting means 204 generates the metadata acquisition request 104, as will be shown below, for each of the one or more addresses included in the metadata acquisition request-generating/transmitting request which it has received (in step ST317).

FIG. 6 is an explanatory view showing the data format of the metadata acquisition request 104.

As shown in FIG. 6, the metadata acquisition request 104 includes a transmission destination address 601 indicating a transmission destination which is acquired from the metadata acquisition request generating/transmitting request, a metadata acquisition request ID 602 for enabling a metadata providing terminal 102 to identify received data as a metadata acquisition request, an address 603 indicating the metadata management terminal 101 which is the transmit source of the metadata acquisition request, and a nickname 604 of the user who uses the metadata management terminal 101 which is the transmit source of the metadata acquisition request.

After generating one or more metadata acquisition requests 104, the metadata acquisition request generating/transmitting means 204 transmits a request to transmit the one or more metadata acquisition requests to the communications means 205 so that the communications means 205 transmits the one or more metadata acquisition requests 104 to the one or more metadata providing terminals at the one or more addresses specified by the one or more metadata acquisition requests 104 (in step ST318). The communications means 205 finally refers to the transmission destination address included in each of the one or more metadata acquisition requests 104 in turn, and transmits the metadata acquisition request to each specified metadata providing terminal via the network 103 (in step ST319).

The metadata providing terminal 102 which has received the metadata acquisition request 104 from the metadata management terminal 101 selects the metadata of contents stored within the terminal, according to, for example, the following criteria, and transmits them, as metadata 105, to the metadata management terminal 101 which has made the request to transmit the metadata 105.
Dispose a folder for storing metadata of contents which are made public, and a folder for storing metadata of contents which are not made public, so as to prevent some metadata from being made public
Prevent metadata which correspond to some contents from being made public according to the genre of the metadata (for example, in the case of video contents: news contents, weather forecast contents, adult contents, etc. are hidden from the public)
Prevent metadata which correspond to some contents whose frequency of using the metadata providing terminal 102 by users is equal to or less than a certain value from being made public
Set an upper limit on the number of metadata to be transmitted so as to prevent transmission of a certain number or more of metadata
Restrict the number of times which the same metadata are transmitted to the same user

Metadata handled by each metadata providing terminal 102 indicate information which describes the descriptions of a video, a sound, or a photo, which exists on the network, or Web contents which are a combination of a video, a sound, and a photo, or one of various pieces of contents information and related information about contents, such as EPG (Electronic Program Guide) for TV program broadcast.

Next, the operation of the metadata management terminal 101 when receiving metadata 105 from a metadata providing terminal 102 will be explained.

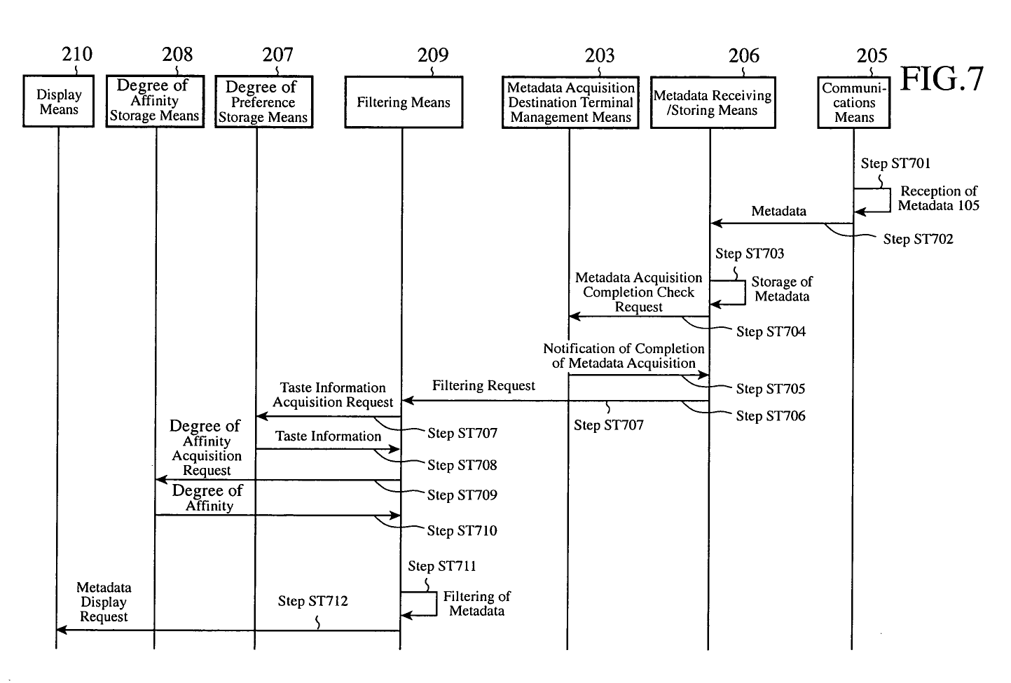

FIG. 7 is a flow chart showing the operation of the metadata management terminal.

First, the communications means 205 receives metadata 105 (in step ST701), and transmits the acquired metadata 105 to the metadata receiving storage means 206 (in step ST702). The metadata receiving storage means 206 which has received the metadata 105 then stores the received metadata therein (in step ST703), and transmits a metadata acquisition completion check request to check to see whether to complete the acquisition of the metadata to the metadata acquisition destination terminal management means 203 (in step ST704).

The metadata acquisition destination terminal management means 203 which has received the metadata acquisition completion check request, checks to see whether a response from each of all terminals which have been registered at the time of generating the metadata acquisition request has been sent to the metadata management terminal, and transmits a notification of the completion of the metadata acquisition to the metadata storing/receiving means 206 when responses from all of the terminals have been sent to the metadata management terminal (in step ST705). The metadata acquisition destination terminal management means performs the aforementioned checking by judging whether it has acquired data from all of the terminals for each of which the data acquisition flag 404 in the terminal address list shown in FIG. 4 which is managed by the metadata acquisition destination terminal management means 203 is “True”. When all of responses from all of the terminals have not been sent thereto, the metadata acquisition destination terminal management means repeats the processes of step ST701 to step ST704. Furthermore, when all of responses from all of the terminals for each of which the data acquisition flag 404 is “True” have not been sent thereto even if a predetermined time has elapsed, the metadata acquisition destination terminal management means notifies this fact to the system control means 202 as an error situation, and advances the operation sequence to step ST706. At that time, the system control means 202 makes a request of the display means 210 to display an error message.

When receiving a notification of the completion of the metadata acquisition from the metadata acquisition destination terminal management means 203, the metadata receiving storage means 206 makes a request of the filtering means 209 to filter the metadata stored therein (in step ST706). The filtering means 209 makes requests of the degree of preference storage means 207 and the degree of affinity storage means 208 to acquire degrees of preference and degrees of affinity, respectively (in steps ST707 and ST709), and acquires the degrees of preference and the degrees of affinity as responses to the requests (in steps ST708 and ST710).

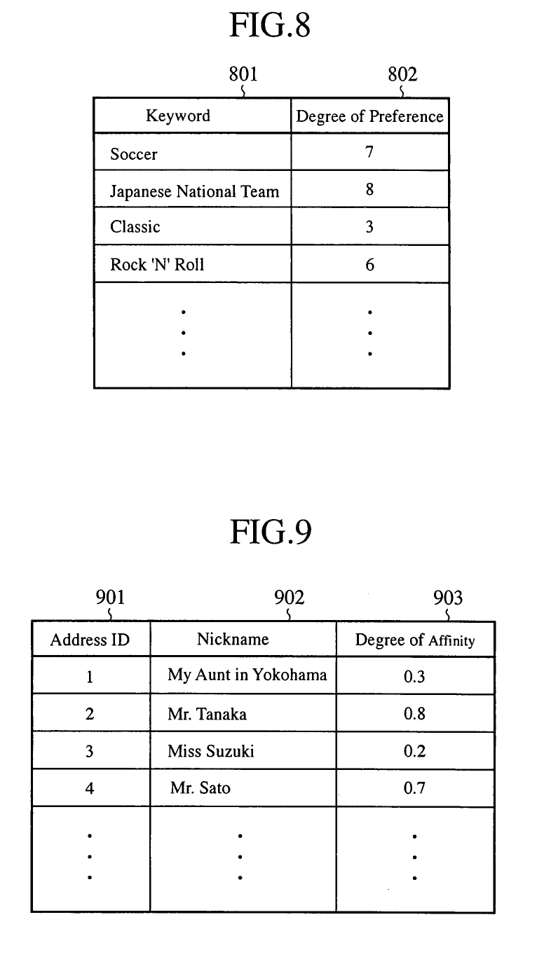

FIG. 8 is an explanatory view showing the degrees of preference.

FIG. 9 is an explanatory view showing the degrees of affinity.

In FIG. 8, a keyword 801 is a keyword which is the target for the user's degree of preference. A degree of preference 802 is a value indicating the degree of a taste for a corresponding keyword 801, and increases with increase in the degree of the taste. In FIG. 9, an address ID 901 is the address ID of a terminal which is the target for measurement of a degree of affinity, and a nickname 902 is the nickname of a user using a corresponding terminal. A degree of affinity 903 is a value indicating the degree of affinity for a corresponding terminal, and increases with increase in the degree of affinity.

Hereafter, how the degrees of preference and the degrees of affinity are stored respectively in the degree of preference storage means 207 and the degree of affinity storage means 208 will be explained.

The degrees of preference can be acquired as will be mentioned, as an example, below.

Each metadata providing terminal 102 in accordance with this embodiment can refer to metadata information which is filtered in such a manner as will be mentioned later, and can play back contents. In this case, the system control means 202 can acquire metadata which correspond to the contents, which the user has actually played back, from the metadata storing/receiving means 206, can decompose the acquired metadata into keywords, and can acquire the frequency of occurrence of each keyword. Sets of {a keyword and the frequency of occurrence of the keyword} which are thus acquired are stored in the degree of preference storage means 207 as shown in FIG. 8.

Degrees of affinity can be acquired as will be mentioned, as an example, below. The system control means 202 can acquire information indicating that the contents which the user has played back are referred to by metadata provided by which metadata providing terminal 102 by inquiring of the metadata storing/receiving means 206 about the information. At that time, the system control means 202 can calculate a degree of affinity for, for example, a metadata providing terminal X as a function of X as follows:

The number of used metadata (X)=
In the case of video or music contents:

The number of metadata which are provided by the metadata providing terminal X, and which are associated with video or music contents each of which have been played back during 60% or more of its playback time.
In the case of Web contents:

The number of metadata which are provided by the metadata providing terminal X, and which are associated with Web contents in each of which 60% or more of the total number of characters displayed by a web browser have been browsed.

The number of provided metadata (X)=the number of metadata provided by the metadata providing terminal X

The degree of affinity (X)=the number of used metadata (X)/the provided metadata (X)

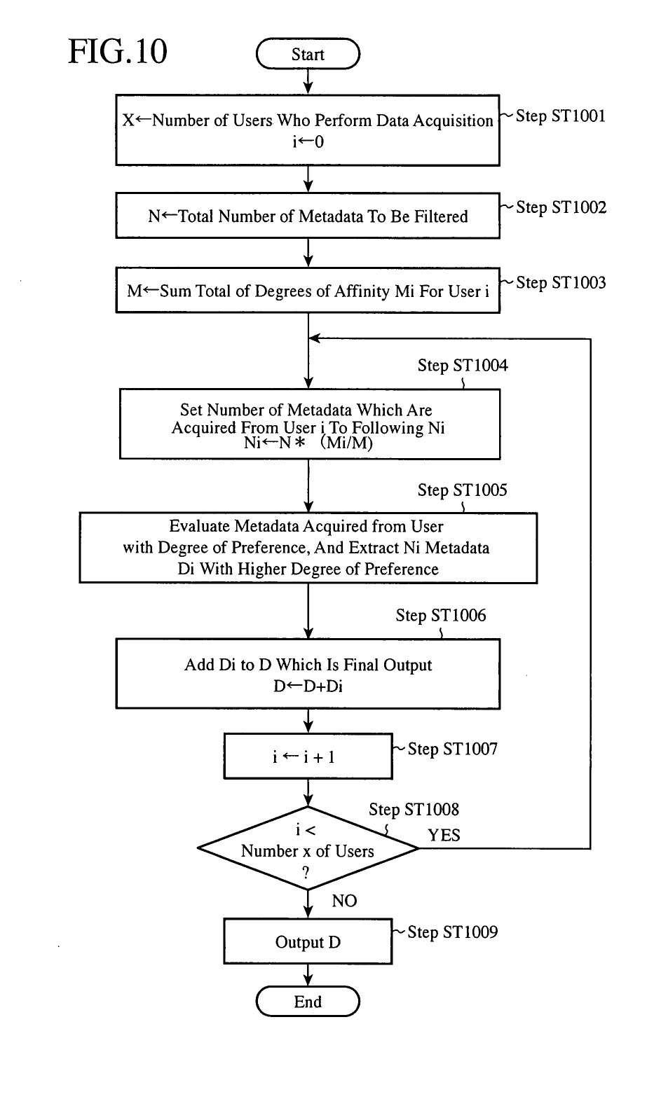

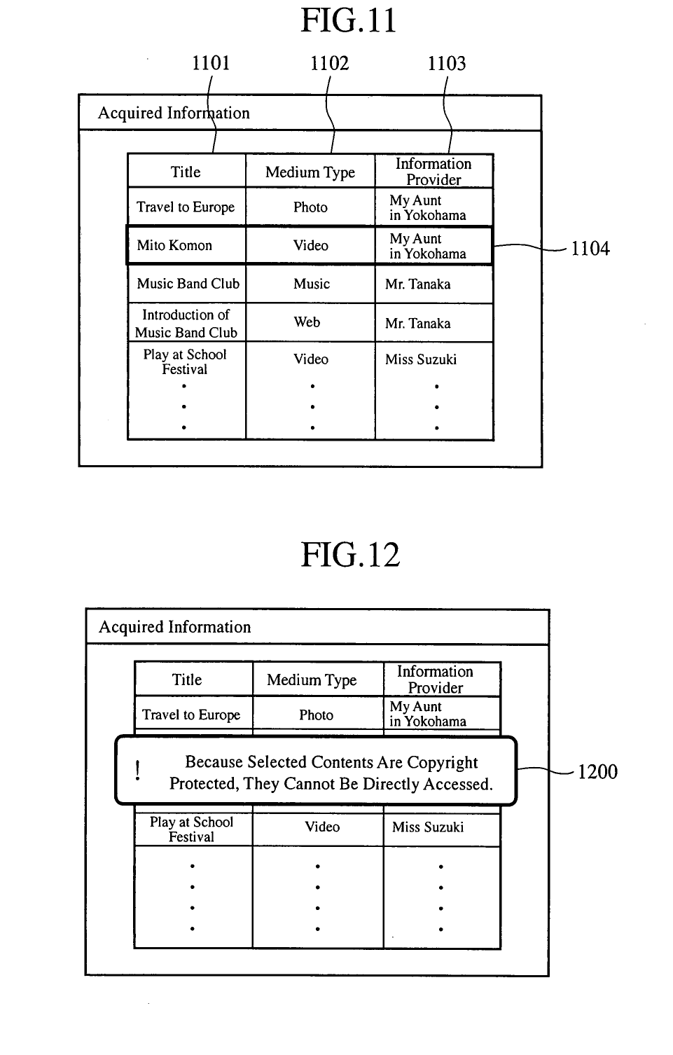

After filtering the metadata with the degrees of preference and the degrees of affinity, as shown, as an example, in a flow chart of FIG. 10 (the details of this flow chart will be mentioned below) (in step ST711), the filtering means 209 makes a request of the display means 210 to display the filtered metadata finally (in step ST712). An example of the display of the metadata displayed on the display means at this time is shown in FIG. 11.

In FIG. 11, a title 1101 is title information about the title of acquired metadata, a medium type 1102 is information indicating the type of the contents associated with the acquired metadata, such as video, music, photo, or Web, a nickname 1103 is a nickname of the user who uses a metadata providing terminal 102 which has provided the metadata to the metadata management terminal, and a cursor 1104 is a cursor for enabling the user to select metadata. At this time, the display means 210 does not have to display metadata as shown in FIG. 11 on the screen all of a sudden. For example, the display means can display a message of “Metadata have been acquired” or the like on an edge of the screen, and can generate a screen display as shown in FIG. 11 according to an instruction by the user.

The details of the filtering operation carried out in step ST711 will be explained with reference to the steps of FIG. 10.

First, the filtering means 209 acquires the metadata which the metadata storing/receiving means 206 has stored therein, acquires the number of users associated with each metadata providing terminal 102 included in these metadata, and substitutes the number of users into X. Each of X users can be referred to as a user 0, . . . , or a user X−1.

In FIG. 10, the filtering means 209 substitutes 0 into an index i which is used to perform a loop process for each user (in step ST1001). Next, the filtering means 209 defines the total number of metadata which are provided, as filtered results, to the user as N, and substitutes a constant like 15 or 20 into N (in step ST1002). The user who uses the metadata management terminal can provide this value explicitly. Next, the filtering means calculates the sum total of the degrees of affinity Mi for the user i as M. This calculation is equivalent to calculation of the sum of the degrees of affinity for users from whom the metadata management apparatus has actually acquired the data among the degrees of affinity for users shown in FIG. 9 (in step ST1003).

Next, the filtering means determines, as Ni, the number of metadata which the metadata management terminal has acquired from the user i from the following equation: N*(Mi/M) (the fractional portion of the number is dropped) (in step ST1004). This means that a larger number N of metadata determined in step ST1002, which are to be filtered, are distributed to users with a higher degree of affinity, whereas a smaller number N of metadata which are to be filtered are distributed to users with a lower degree of affinity. After acquiring Ni, the filtering means evaluates each metadata acquired from the user i on the basis of the degrees of preference acquired from the degree of preference storage means 207, and extracts, as Di, Ni metadata with higher degrees of preference from among the evaluated metadata (in step ST1005). At this time, the filtering means can make the evaluation of each metadata with degrees of preference by using, for example, the sum total of the frequencies of occurrence of keywords which match with each metadata. When the number of metadata acquired from the user i is less than Ni, the filtering means can extract all the acquired metadata as Di. In this case, the total number of metadata filtered becomes less than N.

Finally, the filtering means 209 adds Di which is the metadata acquired from the user i and extracted to D which is the final output of the filtering means 209 (in step ST1006), and increments i by one so as to process the next user (in step ST1007). In order to check whether the filtering means has finished the process for all the users, the filtering means carries out an end process judgment on the following condition: i<the number of users X (in step ST1008). While this condition is satisfied, the filtering means repeats the processes of steps ST1004 to ST1007.

In contrast, because i becomes equal to the value of X and that condition is no longer satisfied when the process is completed for all the users from whom the metadata management terminal has acquired the metadata, the filtering means outputs D which are the final output results of the acquired metadata as filtered results (in step ST1009), and ends the filtering process. Furthermore, the filtering means can output the filtered results after sorting the metadata in such a manner that metadata from a metadata providing terminal 102 with a higher degree of affinity has a higher rank and metadata from a metadata providing terminal 102 with the same degree of affinity has a higher rank as it has a higher degree of taste for the user.

The filtering means carries out the filtering process using information about both degrees of preference and degrees of affinity. As an alternative, the filtering means can carry out the filtering process using information about only either of degrees of preference and degrees of affinity.

The user of the metadata management terminal can operate the user interface as shown in FIG. 11 using the input means 201, as will be mentioned below. A key input which is transmitted when the user operates the input means 201 is converted, via the system control means 202, into the form of a key event which can be interpreted by the display means 210, and is then received by the display means 210. The display means 210 causes the user interface which is managed therewithin to make a state transition according to the received key input, and redraws a screen display if needed.

For example, when the user presses down the cursor key disposed in the input means 201 once in the screen display as shown in FIG. 11, the cursor 1104 is moved downwardly by a one-row distance. When the user then presses down the enter key disposed in the input means 201, the information about the metadata at which the cursor is placed at that time is referred to, and, when the selected contents are a target for copyright protection management, a message as shown in FIG. 12 is displayed. In FIG. 12, 1200 denotes a message dialog displayed when the user is going to access contents which are a target for copyright protection management.

In contrast, when the contents associated with the metadata do not have to be subjected to copyright protection management, the metadata management apparatus directly acquires and plays back video or music contents or the like by referring to the identifier of the contents included in the acquired metadata. The operation of the metadata management apparatus at this time will be mentioned below.

First, the system control means 202 acquires the identifier used for referring to the contents which is included in the metadata which the user has selected from the display means 210. This identifier can be a URL (Uniform Resource Locator) or the like, and the system control means can uniquely determine the location of the contents on the network. The system control means 202 makes a request of the contents acquisition means 211 to acquire the contents specified by the specified URL, and the contents acquisition means 211 creates a message containing the specified URL in a form which complies with HTTP (Hyper Text Transfer Protocol) which is a protocol used for acquiring, for example, a video, a music piece, a photo, a text, or a hypertext in which some of them coexist, and sends out the message to the network via the communications means 205.

When a response to the message saying the aforementioned request to acquire the contents is received by the communications means 205, the contents acquisition means 211 receives the data from the communications means 205. The contents acquisition means 211 changes its operation according to the type of the acquired data, for example, as follows:

In the Case of a Video

For example, when the metadata management apparatus acquires video data which complies with the MPEG (Moving Picture Expert Group) 2 standard, the metadata management apparatus inputs the data to a hardware MPEG2 decoder (not shown) which the contents acquisition means 211 controls, and outputs a decoded picture to the display means 210.

In the Case of a Piece of Music

For example, when the metadata management apparatus acquires music data which complies with the MP3 (MPEG1 Audio Layer-3) standard, the metadata management apparatus inputs the data to a hardware MP3 decoder (not shown) which the contents acquisition means 211 controls, and outputs a decoded sound to the sound output means 212.

In the Case of a Photo

For example, when the metadata management apparatus acquires still picture data which complies with the JPEG (Joint Photographic Experts Group) standard, the contents acquisition means 211 decodes the JPEG file by using a software library, and outputs a decoded image to the display means 210.

In the Case of Web Contents

When the metadata management apparatus acquires an HTTP message containing a HTML (Hypertext Markup Language) document, the metadata management apparatus provides the above-mentioned HTTP message to a web browser which the display means 210 has therein. The web browser which has received the message interprets the acquired HTML document, and displays it on the display means 210.

As mentioned above, the radio base station system in accordance with embodiment 1 includes: the metadata acquisition request generating/transmitting means for generating a metadata acquisition request to acquire metadata from a metadata providing terminal; the metadata storing/receiving means for storing the metadata which are acquired from the metadata providing terminal with the metadata acquisition request; the degree of preference storage means for holding a degree of the user's taste for the metadata; the degree of affinity storage means for storing a degree of affinity between the metadata providing terminal and the user, the degree of affinity being determined from the user's using state of the metadata acquired from the metadata providing terminal; and the filtering means for selecting metadata stored in the metadata storage means by using at least of the degree of preference and the degree of affinity. Therefore, the user can browse the metadata of the contents which he or she likes on a priority basis by using the information on the degree of preference without examine whether or not the information provided for the user is information which interests himself or herself. Also when receiving provision of pieces of information from two or more metadata providing terminals, the user can browse many pieces of information from a terminal having a high degree of affinity for the user by using the information on the degree of affinity without being conscious of whether metadata provided from which terminal interests himself or herself.

Furthermore, because the metadata management apparatus in accordance with embodiment 1 includes the contents acquisition means for referring to the identifier of the contents associated with the metadata which the user has selected so as to acquire the contents, and for playing back the contents, the user can acquire the contents associated with the provided metadata by simply browsing and selecting the metadata, and can enjoy the contents promptly.

### Embodiment 2

A metadata management apparatus in accordance with embodiment 2 manages identification information for identifying a metadata providing terminal for every group. Because the metadata management apparatus according to this embodiment has the same structure as that of embodiment 1 in terms of drawings, the metadata management apparatus will be explained by using FIG. 1 and so on.

In embodiment 1, the user is allowed to select terminals of which the metadata management apparatus will make a request to acquire metadata one by one from the screen as shown in FIG. 5. In contrast, the metadata management apparatus in accordance with this embodiment 2 is so constructed as to collectively register terminals on a group-by-group basis so that the user can simply select a group to make a request to acquire metadata from two or more metadata providing terminals included in the group at a time.

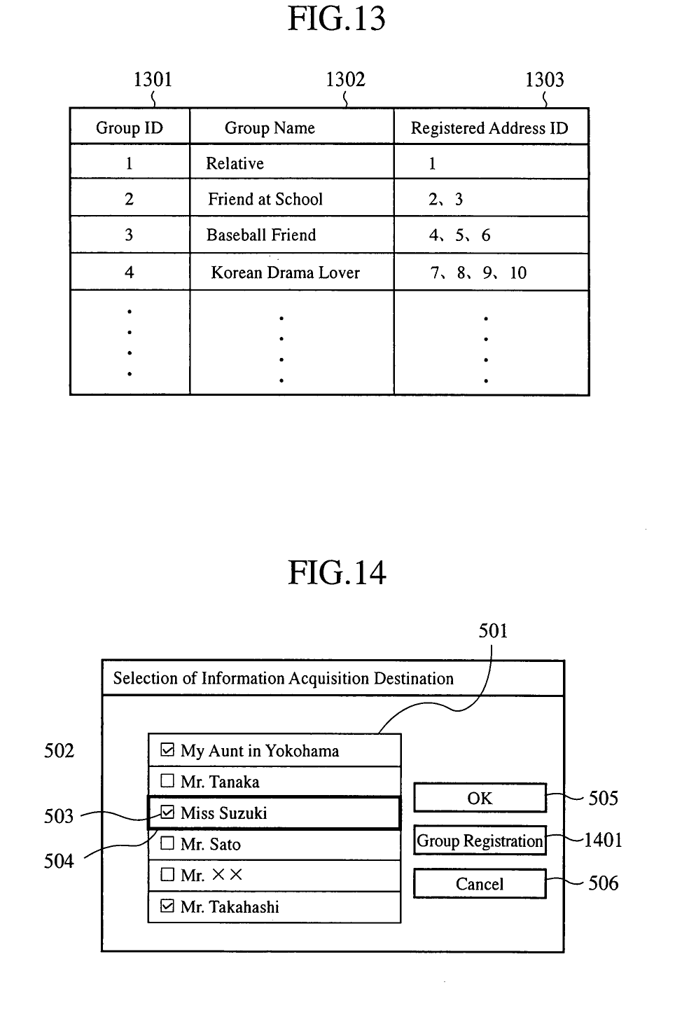

The metadata acquisition destination terminal management means 203 of the metadata providing device in accordance with embodiment 2 has a group management table shown in FIG. 13, in addition to the terminal address list already shown in FIG. 4. In FIG. 13, a group ID 1301 is a number for identifying a registered group, a group name 1302 is a group name which is attached to each group in order for the user to identify each group easily, and a registered address ID 1303 is identification information for identifying the address ID of each terminal which is actually registered into a group. Because components of the metadata management terminal 101 other than these components are the same as those of embodiment 1, the explanation of the components will be omitted hereafter.

Next, the operation of the metadata management terminal of embodiment 2 will be explained.

FIG. 14 is an explanatory view showing an example of a screen display at the time when the user registers a group.

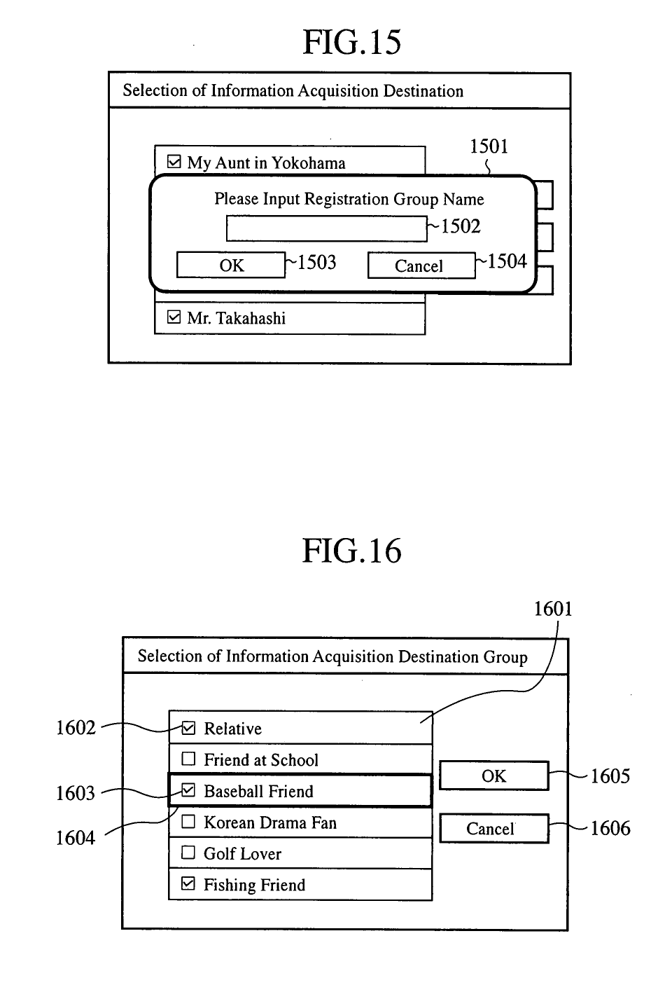

In FIG. 14, the elements designated by the same reference numerals as shown in the terminal address list registration screen display as shown in FIG. 5 have the same functions as those shown in FIG. 5, and therefore the explanation of the elements will be omitted. In the figure, a registering button 1401 is an instruction button for registering, as a group, terminals for which the user checks corresponding check marks. When the user presses down this group registering button 1401 through the input means 201, a message dialog as shown in FIG. 15 is displayed in a form in which it is superimposed on the screen display shown in FIG. 14 so as to urge the user to input a group name to be registered. In FIG. 15, a group name registration dialog 1501 is an input portion for registering a group name, and includes a group name entry form 1502 for inputting a group name, a OK button 1503 for determining the group name, and a cancel button 1504 for gazing at the registration of the group name.

When the user presses down the OK button 1503 after inputting a group name to the group name entry form 1502 by using the input means 201, information on the group name is registered into the group management table which the metadata acquisition destination terminal management means 203 manages. At this time, an integer value being able to uniquely identify the group which is newly registered in the group management table is registered into the group ID, a character string indicating the group name inputted to the group name entry form 1502 is registered into the group name, and an address ID of one or more terminals which the user has selected by checking corresponding one or more check marks in the screen display as shown in FIG. 14 is registered into the registered address ID.

Next, the operation of the metadata management terminal 101 at the time when the user selects a group which he or she has registered will be explained.

When the user makes a request to select metadata providing terminals 102 by specifying a group by using the input means 201, the system control means 202 makes a request of the metadata acquisition destination terminal management means 203 to acquire the group management table. The system control means 202 transmits the acquired group management table to the display means 210, and the display means 210 displays a group selection screen as shown in FIG. 16.

In FIG. 16, a group name 1601 is a group name which is displayed by referring to a corresponding group name 1302 included in the group management table, a check box 1602 is a check box which the user checks when selecting terminals registered into a corresponding group name 1601, a check mark 1603 is a check mark which is displayed when the user checks a corresponding check box 1602, a cursor 1604 is a cursor which the user uses to select a check box 1602 which the user desires to check, a OK button 1605 is an instruction button which the user presses down when finally determining selection of a group, and a cancel button 1606 is an instruction button which the user presses down to stop the selection of the group.

When the user presses down the OK button 1605 after selecting a group by checking a corresponding check mark 1603 in the group selection screen display as shown in FIG. 16, the system control means 202 acquires registered address IDs 1303 which correspond to the group which the user has selected by referring to the group management table held by the system control means 202, and transmits a metadata acquisition destination terminal registration request to the metadata acquisition destination terminal management means 203 together with these address IDs. Because subsequent processes are the same as those of steps ST312 to ST319 in embodiment 1, the explanation of the subsequent processes will be omitted hereafter.

As mentioned above, because the metadata management apparatus in accordance with embodiment 2 has the metadata acquisition destination terminal management means for managing identification information for identifying metadata providing terminals for every group, the user can collectively register metadata providing terminals on a group-by-group basis and therefore does not have to select terminals one by one. As a result, the metadata management apparatus can make a request of two or more metadata providing terminals of a group to acquire metadata at a time by, for example, simply selecting the group.

### Embodiment 3

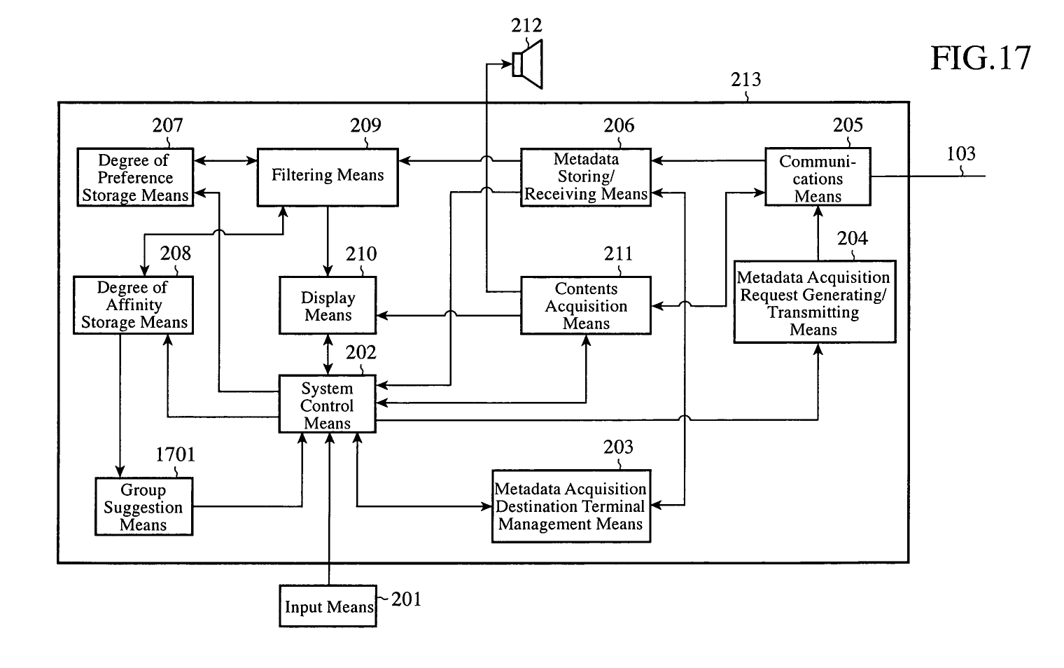

FIG. 17 is a block diagram showing a metadata management terminal to which embodiment 3 in accordance with the present invention is applied.

In the figure, a group suggestion means 1701 is a group suggestion means for detecting metadata providing terminals each of which has a degree of affinity exceeding a predetermined degree of affinity, and for suggesting registering, as a group, those metadata providing terminals into the metadata acquisition destination terminal management means 203. More specifically, the group suggestion means has a function of sending out metadata providing terminals 102 each of which has a degree of affinity exceeding a predetermined degree of affinity as candidates for a group which is managed by the metadata acquisition destination terminal management means 203. Blocks having the same functions as those of the metadata management terminal shown in FIG. 2 are designated by the same reference numerals as shown in FIG. 2, respectively, and the explanation of the blocks will be omitted hereafter. However, assume that the metadata acquisition destination terminal management means 203 is provided with the functions shown in embodiment 2.

Hereafter, the operation of the metadata management terminal in accordance with embodiment 3 will be explained.

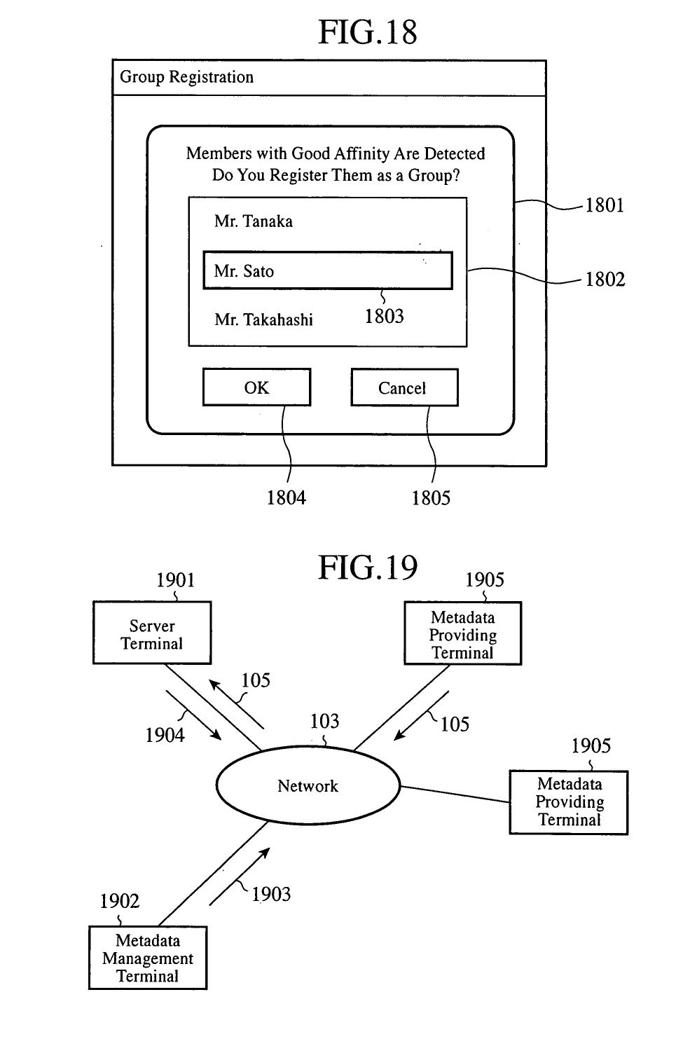

After making a request of the degree of affinity storage means 208 to acquire the degrees of affinity of metadata providing terminals and then acquiring these degrees of affinity, the group suggestion means 1701 detects address IDs which correspond to users to whom values larger than a constant value (e.g., 0.6) which is pre-registered in the group suggestion means 1701 are assigned. Next, the metadata management terminal transmits a notification of group registration suggestion to the system control means 202 together with the detected address IDs and nicknames. The system control means 202 which has received the notification of group registration suggestion transmits the nicknames received thereby to the display means 210, and makes a request to display a screen as shown in FIG. 18 in order to notify the user that a group has been detected.

In the screen shown in FIG. 18, as a group suggestion dialog 1801, a detected member list 1802, a cursor 1803 for selecting a member to exclude this member from this detected member list 1802, a OK button 1804 for registering the group, and a cancel button 1805 for canceling the registration of the group is displayed.

When the user browses members displayed in the detected member list 1802 in FIG. 18, and finds out a member whom the user does not want to register in the group, and deletes the member whom the user wants to delete from the detected member list 1802 after moving the cursor 1803 upwardly or downwardly to select the member. The system control means enables the user to perform the operation of deleting a member by, for example, showing a balloon, such as a popup, so that it overlaps the cursor 1803 (not shown).

When the user judges that the members displayed in the detected member list 1802 can be registered as a group, he or she presses down the OK button 1804 to cause the metadata management terminal to carry out the group registration. In contrast, when the user judges that the metadata management terminal does not have to carry out the group registration, he or she can stop the group registration by pressing down the cancel button 1805.

When the OK button 1804 is selected, the display means 210 displays a group name registration dialog as shown in FIG. 15, and receives an input of a group name to be registered from the user. When the user presses down the OK button 1503 after inputting a group name to the group name entry form 1502 by using the input means 201, the display means 210 makes a request of the metadata acquisition destination terminal management means 203 to register the group via the system control means 202. At this time, an integer value being able to uniquely identify the group which is newly registered in the group management table is registered into the group ID, a character string indicating the group name inputted to the group name entry form 1502 is registered into the group name, and an address ID of the group to be registered which the system control means 202 has received from the group suggestion means 1701 is registered into the registered address ID.

After the metadata management terminal has completed the group registration, the user can select a group through a group selection screen display as shown in FIG. 16 so as to acquire metadata from the group, as in the case of performing the operation shown in embodiment 2.

As mentioned above, the metadata management apparatus in accordance with embodiment 3 includes the group suggestion means for detecting metadata providing terminals each of which has a degree of affinity exceeding a predetermined degree of affinity, the degree of affinity being determined on the basis of the user's using state of the contents provided by each target metadata providing terminal, and for sending out information indentifying the detected metadata providing terminals as candidates for a group which is managed by the metadata acquisition destination terminal management means. Therefore, the present embodiment offers an advantage of enabling the user to automatically receive suggestion of registration of a degree of affinity-based group which can be a destination of acquisition of metadata, and to easily make a request of two or more metadata providing terminals to acquire metadata at a time without selecting other users whom the user desire to register as a group by himself or herself.

### Embodiment 4

FIG. 19 is a block diagram showing a network system to which a metadata management apparatus in accordance with embodiment 4 of the present invention is applied.

In the figure, because a network 103 and metadata 105 are the same as those shown in FIG. 1, the explanation of the network and the metadata will be omitted hereafter. A server terminal 1901 is a terminal which manages metadata acquired from two or more metadata providing terminals 1905, and transmits a metadata list 1904 to a metadata management terminal 1902 in response to a request from the metadata management terminal 1902.

The metadata management terminal 1902 is a terminal which makes a request to acquire metadata provided by the two or more metadata providing terminals 1905 by transmitting a metadata acquisition request 1903 to the server terminal 1901, and which acquires the metadata list 1904 from the server terminal 1901. The metadata management terminal 1902 corresponds to the metadata management terminal 101 in accordance with embodiment 1. More specifically, a metadata acquisition request generating/transmitting means 204 in the metadata management terminal 1902 in accordance with embodiment 4 has a function of generating a metadata acquisition request 1903 to acquire metadata which the user desires from the server terminal 1901. Because structural components of the metadata management terminal 1902 other than this component are the same as those of the metadata management terminal 101 in accordance with embodiment 1, the explanation of the other structural components will be omitted hereafter.

The metadata list 1904 is data transmitted to the metadata management terminal 1902 as a response to the metadata acquisition request 1903 from the server terminal 1901. Furthermore, each metadata providing terminal 1905 is a terminal which, when the metadata held therein change periodically or, transmits the metadata to the server terminal 1901, and corresponds to a metadata providing terminal 102 in accordance with embodiment 1.

Hereafter, the operation of the metadata management terminal 1902 in accordance with embodiment 4 will be explained.

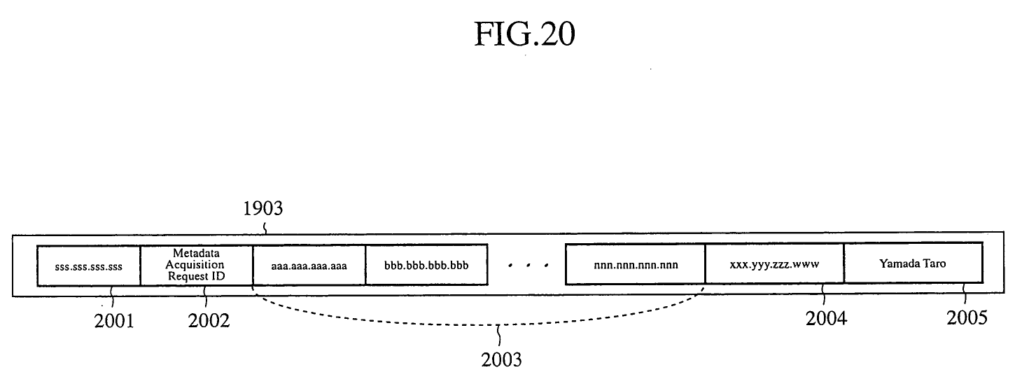

Because the operation up to step ST315 in FIG. 3 of the metadata management terminal in accordance with embodiment 4 is the same as that of the metadata management terminal in accordance with embodiment 1, the explanation of the operation will be omitted hereafter and the operation of step ST316 and subsequent steps will b explained with reference to FIG. 3. The metadata acquisition request generating/transmitting means 204 which has received a metadata acquisition request generating/transmitting request from the system control means 202 combines one or more real addresses included in the received metadata acquisition request generating/transmitting request to generate one metadata acquisition request 1903, as shown in FIG. 20.

As shown in FIG. 20, the metadata acquisition request 1903 includes a transmission destination address 2001 for specifying the server terminal 1901, a metadata acquisition request ID 2002 for identifying that data which the server terminal 1901 has received is the metadata acquisition request 1903, a metadata providing terminal address list 2003 which is a series of one or more combined real addresses included in the metadata acquisition request generating/transmitting request, the address 2004 of the metadata management terminal 1902 which is the transmit source of the metadata acquisition request, and the nickname 2005 of the user who uses the metadata management terminal 1902 which is the transmit source of the metadata acquisition request 1903.

When the metadata acquisition destination terminal management means 203 generates the metadata acquisition request 1903 as mentioned above, the metadata acquisition request generating/transmitting means 204 transmits a metadata acquisition request transmission request to the communications means 205 together with the generated metadata acquisition request 1903 (in step ST318), and the communications means 205 transmits the metadata acquisition request 1903 to the server terminal 1901 specified by the transmission destination address 2001.

The server terminal 1901 which has received the metadata acquisition request 1903 compares the metadata stored in the local terminal with the metadata providing terminal address list 2003 included in the metadata acquisition request 1903, collects the metadata which match with the metadata providing terminal address list to generate a metadata list 1904, and transmits the metadata list 1904 to the metadata management terminal 1902. Because the process carried out after receiving the metadata list 1904 is the same as the operation shown in embodiment 1, the explanation of the process will be omitted hereafter.

As mentioned above, the metadata management apparatus in accordance with embodiment 4 includes: the metadata acquisition request generating/transmitting means for generating a metadata acquisition request to acquire metadata which the user desires from the server terminal which manages metadata which the server terminal has acquired from a plurality of metadata providing terminals; the metadata storing/receiving means for storing the metadata which are acquired from a metadata providing terminal with the metadata acquisition request; the degree of preference storage means for holding a degree of the user's taste for the metadata; the degree of affinity storage means for storing a degree of affinity between the metadata providing terminal and the user, the degree of affinity being determined from the user's using state of the metadata acquired from the metadata providing terminal; and the filtering means for selecting metadata stored in the metadata storage means by using at least of the degree of preference and the degree of affinity. Therefore, in order to acquire metadata provided by each metadata providing terminal specified by the user, the metadata management apparatus has only to transmit a metadata acquisition request to the server terminal once without transmitting the metadata acquisition request independently to each metadata providing terminal.

### INDUSTRIAL APPLICABILITY

As mentioned above, the metadata management apparatus in accordance with the present invention is suitable for use in a system in which plural terminals each of which uses metadata in which a description of contents, such as a video or a piece of music, is written are connected to a network, and metadata are acquired and provided among terminals, and so on.

1. A metadata management apparatus comprising:
a metadata acquisition request generating/transmitting means for generating a metadata acquisition request to acquire metadata from a metadata providing terminal;
a metadata storing/receiving means for storing the metadata which are acquired from said metadata providing terminal with said metadata acquisition request;
a degree of preference storage means for holding a degree of a user's taste for the metadata;
a degree of affinity storage means for storing a degree of affinity between said metadata providing terminal and said user, the degree of affinity being determined from said user's using state of the metadata acquired from said metadata providing terminal; and
a filtering means for selecting metadata stored in said metadata storage means by using at least of said degree of preference and said degree of affinity.

2. The metadata management apparatus according to claim 1, characterized in that said apparatus comprises a contents acquisition means for referring to an identifier of contents associated with metadata which the user has selected so as to acquire the contents, and for playing back the contents.

3. The metadata management apparatus according to claim 1, characterized in that said apparatus comprises a metadata acquisition destination terminal management means for managing identification information for identifying metadata providing terminals for every group.

4. The metadata management apparatus according to claim 3, characterized in that said apparatus comprises a group suggestion means for detecting a metadata providing terminal which has a degree of affinity exceeding a predetermined degree of affinity, and for sending out information identifying the detected metadata providing terminal as a candidate for a group which is managed by the metadata acquisition destination terminal management means.

5. A metadata management apparatus comprising:
a metadata acquisition request generating/transmitting means for generating a metadata acquisition request to acquire metadata which a user desires from a server terminal which manages metadata which said server terminal has acquired from a plurality of metadata providing terminals;
a metadata storing/receiving means for storing the metadata which are acquired from said metadata providing terminal with said metadata acquisition request;
a degree of preference storage means for holding a degree of a user's taste for the metadata;
a degree of affinity storage means for storing a degree of affinity between said metadata providing terminal and said user, the degree of affinity being determined from said user's using state of the metadata acquired from said metadata providing terminal; and
a filtering means for selecting metadata stored in said metadata storage means by using at least of said degree of preference and said degree of affinity.
